(19) United States
(12) Patent Application Publication
(10) Pub. No.: US 2005/0229046 A1
(43) Pub. Date: Oct. 13, 2005

(54) Evaluation of received useful information by the detection of error concealment

(76) Inventors: Matthias Marke, Grobenzell (DE); Wen Xu, Unterhaching (DE)

Correspondence Address: BELL, BOYD & LLOYD, LLC, P. O. BOX 1135, CHICAGO, IL, 60690-1135, US

(21) Appl. No.: 10/523,326

(22) PCT Filed: Jul. 24, 2003
(86) PCT No.: PCT/DE03/02498

§ 371 Date: Feb. 1, 2005

(30) Foreign Application Priority Data
Aug. 2, 2002 (WO) PCT/EP02/08652
Sep. 4, 2002 (DE) 102 40 902.1

(51) Int. Cl. G06F 11/00

(52) U.S. Cl. 714/100

(57) ABSTRACT

The present invention relates to an effective option for recognizing error concealment, provided by a method and a device for evaluating data containing useful information that has been received via a communications network. The present invention is characterized in that the use of error concealment is detected after receipt through a statistical analysis of the useful information.

### BACKGROUND OF THE INVENTION

For the digital transmission of speech over error-prone channels, source encoding methods are used to minimize the transmission bandwidth needed. A channel code protects the compressed data against transmission errors. If a channel decoder can detect errors in transmission (e.g., parity checking, CRC) and notify the source decoder about the susceptibility of the data to errors, the source decoder can use error concealment mechanisms to improve the speech quality of the received data. However, if the speech channel is used to transmit modulated useful information, such as text for text telephony=CTM (Cellular Text telephone Modem), documents, graphics, multimedia data, etc., error concealment is no longer the best idea for the transmission of such useful information. Useful information is the information inserted on the sender side into the data stream and retrieved from the data on the receiver side; for example, text, speech, picture, video signals, etc. In such cases, the data is the received signals which are encoded in a typical way for the transmission. For transmission of text in accordance with the US American Text Telephony standard (cf. 3GPP TS 26.226) through digital encoding of an alphabet, channel encoding and frequency modulated transmission over a speech channel, it may occur that a section of this speech channel runs over a mobile radio channel. To guarantee secure transmission of emergency calls there are maximum prescribed error rates set down for the transmission of the individual letters (cf. 3GPP TS 26.231). If an Adaptive Multi Rate (AMR) voice codec is used in this mobile radio channel, error concealment is used for detecting an incorrectly received speech frame. This involves using parameters of the last correctly received speech frame. In addition, parameters of the four 5 ms long subframes of the last 20 ms long MR frame sent are averaged. For the demodulator of the text telephony system this results in, at a point in time t, instead of a very noisy signal which would generate bad reliability information in the demodulator and thereby would not be taken into account so much for channel decoding, a signal from the past is demodulated which actually no longer contains any valid information but is received for demodulation with less noise. For this signal, despite its incorrect information, high reliability values which specify that the signal could be reliably decoded are generated, although such is not correct for text here. The result is high error rates after channel decoding which is not evident from the reliability information.

WO 98/48531 describes a method for concealing errors in an audio data stream. The occurrence of an error in the audio data stream is recorded, where audio data is intact audio data before the error occurred. Subsequently, spectral energy of a subgroup of the intact audio data is calculated. After formation of a template for replacement data based on the spectral energy calculated for the subgroup of the intact audio data, replacement data for incorrect or missing audio data which corresponds to the subgroup is created on the basis of the template.

Dorbecker M et al (“The cellular text telephone modem—the solution for supporting text telephone functionality in GSM networks” 2001 IEEE International Conference on Acoustics, Speech, and Signal Processing; Proceedings (CAT. NO. 01CH37221), 2001 IEEE International Conference on Acoustics, Speech, and Signal Processing; Proceedings, Salt Lake City, Utah, USA, 7-11 May 2001, second 1441-1444 vol. 3, XPO02261951 2001, Piscataway, N.J., USA, IEEE, USA, ISBN:0-7803-7041-4) shows that text telephony devices are text-based input devices which allow users to communicate via text over a fixed network. For the North American mobile radio standard PCS-1900, an option for using the CTM signals is proposed. This option is independent of the mobile radio network used and functions with all speech channels.

The present invention seeks to provide a method and a device in a cellular mobile communication network for receive-side detection of received useful information which cannot be reliably detected.

### SUMMARY OF THE INVENTION

Accordingly, the present invention provides a method for receive-side detection of an error concealment (e.g., of a speech decoder decoding the received data), on the basis of the static parameters obtained from the receive data. This generally may be used for the transmission of useful information, such as speech, picture, video signals, etc., for which error concealment is used on the receive side. With a CTM device, reliability information (soft values) is handled or weighted differently according to error concealment (present or not present). With AMR speech transmission in a mobile communication network, the AMR mode can be switched over with the aid of the present invention in order to minimize error concealment. With other applications for data transmission, this method can be used with respect to the quality of the transmitted data to come to a decision about whether data is to be transmitted once again. A significant advantage of this method is that no explicit information of a receiver about the use of error concealment is needed, making it suitable for accessories as well. If this method is used for external CTM (Cellular Text telephone Modem) add-on devices, the CTM device functions without adaptation with different makes of mobile radio terminals. The present invention can be used to come to a reliable decision as to whether the received useful information has been corrupted by error concealment. Furthermore, the error rates during transmission can be minimized, which represents a major advantage, particularly for emergency calls.

Additional features and advantages of the present invention are described, and will be apparent from, the following Description of the Invention and the Figures.

### BRIEF DESCRIPTION OF THE FIGURES

FIG. 1 shows a simplified diagram of the statistical analysis of data for detection of the use of error concealment after speech decoding of the data has been completed.

### DETAILED DESCRIPTION OF THE INVENTION

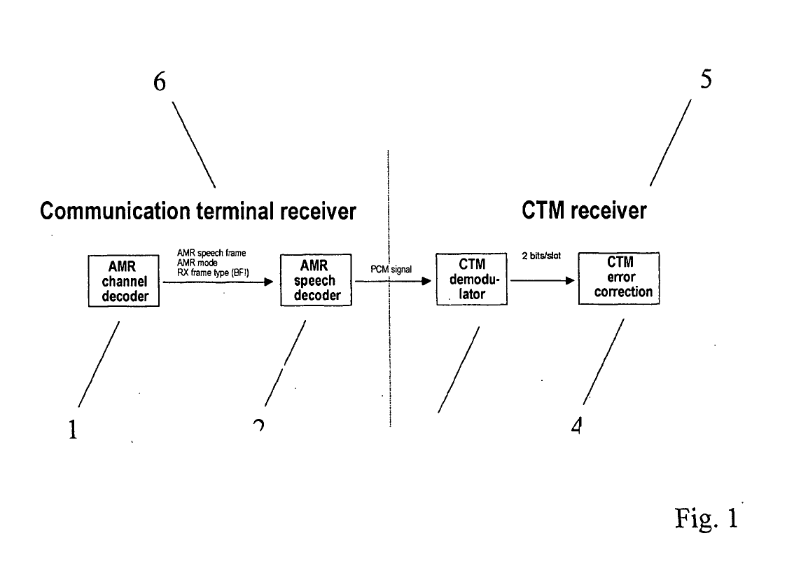

FIG. 1 shows how an AMR channel decoder in an AMR receiver (6) receives the transmitted data from an equalizer in the form of TDMA bursts. The AMR channel decoder (1) corrects channel errors as far as possible. On the basis of a checksum (CRC), the AMR channel decoder (1) detects whether the channel-decoded AMR speech frame is usable or unusable (in the sense of being too greatly disrupted by the transmission). It transfers to the AMR speech decoder (2) the decoded speech frame, the AMR mode and the supplementary information about whether the frame is usable. The latter information is contained in the parameter RX FRAME TYPE (BFI=Bad Frame Indicator). The AMR speech decoder (2) uses the BFI (Bad Frame Indicator), to not convert unusable frames directly into speech (audio signal) but, in this case, to synthesize the data containing the useful information from frames of the past such that the human ear only perceives a minimal disturbance (error concealment). A PCM (Pulse Code Modulation) signal is present at the output of the module (2).

The source-decoded audio signal is investigated for characteristic features of error concealment which allow it to be concluded upon decoding in the time window investigated that there is a sufficiently great likelihood of error concealment having been used. The information thus obtained as to whether error concealment is likely to be present is included in reliability information specifying the reliability of correct demodulation of the useful information which the demodulator (3) of the data containing useful information supplies. If it is likely that error concealment has been used for useful information in the demodulation time window, the reliability (=likelihood), of the useful information having been appropriately (=correctly) decoded, that is of it corresponding to the transmitted useful information, falls. The reliability information is thus defined as a lower value than if no use of error concealment had been detected. A subsequent channel decoding of the data containing useful information can better identify and correct errors with this reliability information. Useful information may consist of numbers, letters or numbers and letters, for example. The CTM receiver (5) includes a demodulator unit (3) and the error correction module (4). Initially, two bits which are contained frequency-modulated in the PCM signal are generated from 40 PCM signal values. Reliability information is added to the bits. The reliability information is incorrectly high if the 40 signal values come from an AMR which was actually received as unusable. The error concealment refers to the signal having few acoustic noise components, but has taken the frequency-modulated information from a speech frame of the past and thus cannot be utilized at the current point in time.

The information about whether error concealment was applied no longer can be taken directly from the PCM signal. At the CTM receiver (5), 2 bits frequency-modulated (4 frequencies) are transmitted every 5 ms. The frequency which is the most likely to have been transmitted is determined with a correlation demodulator (3). A CTM (Cellular Text telephone Modem) is a modem which makes it possible to transmit text messages over speech channels in mobile radio systems. Independently of the speech channel (Fullrate Speech, Halfrate Speech, Enhanced Fullrate Speech, AMR, future technologies), information can be transmitted by those with hearing or speech difficulties using encoded and frequency-modulated transmission of text in the voice frequency band.

Unlike other text telephony standards which are designed for fixed networks, CTM is developed with robust error protection for mobile transmission. The CTM either is an external add-on device for mobile telephones or is integrated into the mobile telephone, implemented as DSP code in the firmware.

This information as well as the specifications relating to reliability is transferred to the channel decoder of the CTM system. The signal energy also may be measured. 5 ms corresponds to a quarter of an AMR frame of 20 ms. With error concealment in the AMR receiver (6), parameters from earlier correctly-received frames are repeated, wherein at a point in time t, a signal is output which is very similar to the signal at point t minus 20 ms but has lower signal energy (the gain factors are attenuated). The comparison between the frequency detected at point t and the signal energy with the detected frequency and signal energy at point t minus 20 ms thus enables the conclusion to be drawn, with the same frequency and lower signal energy at point t that it is quite likely that error concealment has been used and the reliability information of the CTM demodulator (3) can be changed so that it specifies a low reliability. The same procedure may be used if the same frequency is detected in directly consecutive 5 ms subframes and signal energy which remains the same or falls is measured, since this is also a symptom for the application of error concealment in demodulation that has been undertaken. With AMR error concealments, parameters of the subframes are averaged and, thus, similar signals are output over 4 subframes. These two approaches and an optimally parameterized attenuation of the information enable the error rate for transmission of letters to be reduced by approximately 20 percent. The statistical investigations conducted in connection with the present invention allow estimation as to whether error concealment has been used. The reliability information then may be adapted, wherein for text/(CTM) data, it can be appropriately specified whether there is a high or low likelihood (=more or less reliable) that it has been appropriately demodulated, since this depends on the use of error concealment (unsuitable for text/(CTM) data) during demodulation. The data consists of the useful information for CTM still with the header and other information.

Although the present invention has been described with reference to specific embodiments, those of skill of the art will recognize that changes may be made thereto without departing from the spirit and scope of the present invention as set forth in the hereafter appended claims.

1-13. (canceled)

14. A method for evaluating data containing useful information received via a communication network, the method comprising:
evaluating and at least partially correcting, via a channel decoder, the data received;
forwarding, via the channel decoder, to a speech decoder the data with characteristics of supplementary information representing the data;
decoding the data via the speech decoder and, where necessary, performing error concealment;
forwarding the data to a text telephony receiver via the speech decoder;
evaluating the data received and analyzing the data statistically, via a demodulator in the text telephony receiver, by measuring a signal energy;
generating, via the demodulator, reliability information relating to the data received;
forwarding the data, via the demodulator, with the reliability information to an error correction modulator; and
correcting the data received, via the error correction modulator, taking into account the reliability information.

15. A method for evaluating data containing useful information as claimed in claim 14, further comprising determining a likelihood of the reliability information representing appropriate decoding of the data received as a function of a result of the error concealment.

16. A method for evaluating data containing useful information as claimed in claim 15, further comprising providing a channel decoder which takes account of the reliability information for channel decoding.

17. A method for evaluating data containing useful information as claimed in claim 14, wherein the data is emergency call-related data.

18. A method for evaluating data containing useful information as claimed in claim 14, wherein the data is analyzed in a mobile station.

19. A method for evaluating data containing useful information as claimed in claim 14, wherein the data is transmitted over a cellular mobile communication network.

20. A method for evaluating data containing useful information as claimed in claim 14, wherein for statistical detection of an error concealment by the speech decoder, time segments of frames of the received useful information are analyzed.

21. A method for evaluating data containing useful information as claimed in claim 20, wherein the time segments are analyzed in a text telephony demodulator.

22. A method for evaluating data containing useful information as claimed in claim 14, wherein the error correction modulator is located in the text telephony receiver.

23. A method for evaluating data containing useful information as claimed in claim 14, wherein the data is encoded with Adaptive Multi Rate.

24. A method for evaluating data containing useful information as claimed in claim 14, wherein the useful information includes at least one of text, speech, picture and video signals.

25. A device for evaluating data containing useful information received via a communication network, comprising:
a channel decoder in a communication terminal receiver for evaluating and at least partially correcting the received data, and for forwarding the data with characteristics of supplementary information representing the data to a speech decoder;
a speech decoder for decoding and, if necessary, performing error concealment, and for forwarding the data to a text telephony receiver;
a demodulator in the text telephony receiver for evaluating and statistically analyzing the received data by measuring a signal energy, for creating reliability information relating to the data and for forwarding the data with the reliability information to an error correction modulator; and
an error correction modulator for correcting the received data, taking into account the reliability information.
